(19) United States
(12) Patent Application Publication
(10) Pub. No.: US 2010/0180072 A1
(43) Pub. Date: Jul. 15, 2010

(54) MEMORY CONTROLLER, NONVOLATILE MEMORY DEVICE, FILE SYSTEM, NONVOLATILE MEMORY SYSTEM, DATA WRITING METHOD AND DATA WRITING PROGRAM

(76) Inventors: Shigekazu Kogita, Osaka (JP); Takuji Maeda, Osaka (JP); Hiroki Etoh, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/664,954

(22) PCT Filed: Jun. 9, 2008
(86) PCT No.: PCT/JP2008/001459

§ 371 Date: Dec. 16, 2009

(30) Foreign Application Priority Data
Jun. 22, 2007 (JP) 2007-165385

(51) Int. Cl. G06F 12/02; G06F 12/10

(52) U.S. Cl. 711/103; 711/209; 711/E12.058; 711/E12.008

(57) ABSTRACT

A file system (105) and a nonvolatile memory device (101) notify each other of the cluster size and the logic block size respectively in advance. In writing, the file system notifies the nonvolatile memory device of data as to which cluster of the file system can be discarded in the logical block of the nonvolatile memory device. With this, the nonvolatile memory device can avoid the copy of data at the writing, so that the nonvolatile memory device is not required to continuously keep data of an unnecessary file.

### TECHNICAL FIELD

The present invention relates to a nonvolatile memory device such as a semiconductor memory card having a rewritable nonvolatile memory such as a flash memory as a data memory medium, a memory controller built in the nonvolatile memory device, and a file system for writing and reading data with respect to the nonvolatile memory device, and furthermore, to a nonvolatile memory system having the nonvolatile memory device as a component in the file system, a data writing method, and a data writing program.

### BACKGROUND ART

A nonvolatile memory device equipped with a rewritable nonvolatile memory such as a flash memory has been widely used mainly as a semiconductor memory card and has been increasingly demanded as a nonvolatile memory system combined with a digital still camera, a personal computer and the like. Recently, various kinds of semiconductor memory cards exist.

The memory card is composed of a flash memory for storing data therein and a memory controller LSI for controlling the flash memory. The memory controller LSI is a device for controlling writing/reading data with respect to the flash memory according to a writing/reading instruction from an access device such as a digital still camera. A typical flash memory is a NAND type flash memory.

A plurality of physical blocks each acting as a data erasure unit exist in the flash memory and a plurality of pages each acting as a data writing/reading unit exist in each physical block. The size of the page as the data writing/reading unit is smaller than that of the physical block as the erasure unit. The memory controller LSI manages one or the plurality of physical blocks as one logical block. In the case where the plurality of physical blocks are managed as one logical block, speeding up is attempted by performing parallel writing or parallel erasure.

Meanwhile, a file system for writing/reading data with respect to the nonvolatile memory device manages a memory area in a cluster unit. One cluster is, for example, 16 k bytes and one or a plurality of clusters are collectively managed as one file.

In recent years, due to an increase in the erasure block size of the flash memory and speeding up of the nonvolatile memory device, a logical block size tends to become larger and the a cluster size is generally smaller than the logical block size.

In deleting a file, the file system only deletes the file on file management information and generally, does not delete actual data itself written into the nonvolatile memory device. For this reason, since the nonvolatile memory device processes even unnecessary data without recognizing that the data is unnecessary and retains the unnecessary data, disadvantageously, writing speed may decreases or the number of times of writing may increases.

A method disclosed in, for example, Patent Document 1 addresses the problem. In Patent Document 1, the writing speed is increased by searching a free area and previously deleting unnecessary data on the basis of file management information before the file system writes data into the nonvolatile memory device.
Patent Document 1: Japanese Unexamined Patent Publication No. 2005-85081

### DISCLOSURE OF INVENTION

### Problems to be Solved by the Invention

However, according to the conventional method, a file system needs to explicitly delete data in a nonvolatile memory device. In addition, there is a problem that writing speed is not always improved since an erasure range designated by the file system and a method of controlling erasure in the nonvolatile memory device differ.

According to the present invention, the file system and nonvolatile memory device recognize respective management units mutually, and in writing, the file system notifies the nonvolatile memory device which a management unit of the file system in the management unit of the nonvolatile memory device may be abandoned. An object of the present invention is to increase the writing speed of the nonvolatile memory device and furthermore, improve reliability of the nonvolatile memory device by reducing the number of time of rewriting of the nonvolatile memory.

### Means to Solve the Problems

To solve the problem, the memory controller of the present invention for writing data into a nonvolatile memory composed of a plurality of physical blocks based on a command from a memory access device and reading data from said nonvolatile memory comprising: an address conversion manager for associating an address of a logical block managing said nonvolatile memory with an address of a physical block retaining data in the logical block; an empty block manager including an empty block management table representing a usage state of said physical block; an empty unit information manager for retaining a bit map table representing an arrangement of valid data in a management unit together with data to be written in writing data and a logical address; and a controller for selecting an empty physical block based on said empty block management table in writing data into the logical block including the valid data, writing new data into the selected empty physical block, and copying only valid data in the logical block based on said bit map table representing the valid data in the management unit given together with a writing command.

In the memory controller, said address conversion manager may include a next writing pointer representing a next writing position in said logical block.

In the memory controller, said controller may notify an external memory access device of a unit of said logical block and receive a data management unit from said memory access device.

In the memory controller, the data management unit received from said memory access device may be a capacity of a cluster.

To solve the problem, a nonvolatile memory device of the present invention comprises: a nonvolatile memory composed of a plurality of physical blocks; and a memory controller for writing data into said nonvolatile memory based on a command from a memory access device and reading data from said nonvolatile memory, wherein said memory controller includes: an address conversion manager for associating an address of a logical block managing said nonvolatile memory with an address of a physical block retaining data in the logical block; an empty block manager including an empty block management table representing a usage state of said physical block; an empty unit information manager for retaining a bit map table representing an arrangement of valid data in a management unit together with data to be written in writing data and a logical address; and a controller for selecting an empty physical block based on said empty block management table in writing data into the logical block including the valid data, writing new data into the selected empty physical block, and copying only valid data in the logical block based on said bit map table representing the valid data in the management unit given together with a writing command.

In the nonvolatile memory device, said address conversion manager may include a next writing pointer representing a next writing position in said logical block.

In the nonvolatile memory device, said controller may notify an external memory access device of a unit of said logical block and receive a data management unit from said memory access device.

In the nonvolatile memory device, the data management unit received from said memory access device may be a capacity of a cluster.

In the nonvolatile memory device, said nonvolatile memory may be a flash memory.

To solve the problem in a file system of the present invention for writing and reading data with respect to a nonvolatile memory device, in writing data into said nonvolatile memory device, area information in a management unit having no valid file data in the logical block of said nonvolatile memory device is notified to said nonvolatile memory device.

To solve the problem, a nonvolatile memory device comprises: a nonvolatile memory composed of a plurality of physical blocks; a memory controller for writing data to said nonvolatile memory and reading data from said nonvolatile memory; and a file system for instructing writing and reading of data with respect to said memory controller, wherein said memory controller includes: an address conversion manager for associating an address of a logical block managing said nonvolatile memory with an address of a physical block retaining data in the logical block; an empty block manager including an empty block management table representing a usage state of said physical block; an empty unit information manager for retaining a bit map table representing an arrangement of valid data in a management unit together with data to be written in writing data and a logical address; and a controller for selecting an empty physical block based on said empty block management table in writing data into the logical block including the valid data, writing new data into the selected empty physical block, and copying only valid data in the logical block based on said bit map table representing the valid data in the management unit given together with a writing instruction, and in instructing writing of data to said memory controller, said file system notifies said memory controller of area information in said management unit having no valid file data in the logical block of said memory controller.

In the nonvolatile memory device, said address conversion manager may include a next writing pointer representing a next writing position in said logical block.

In the nonvolatile memory device, said controller may notify said file system of a unit of said logical block and receive a data management unit from said file system.

In the nonvolatile memory device, the data management unit received from said file system may be a capacity of a cluster.

In the nonvolatile memory device, said nonvolatile memory may be a flash memory.

To solve the problem, a nonvolatile memory system comprises: a nonvolatile memory composed of a plurality of physical blocks; a memory controller for writing data to said nonvolatile memory and reading data from said nonvolatile memory; a file system for instructing writing and reading of data with respect to said memory controller; and a file access device for writing, reading, and deletion of a file, wherein said memory controller includes: an address conversion manager for associating an address of a logical block managing said nonvolatile memory with an address of a physical block retaining data in the logical block; an empty block manager including an empty block management table representing a usage state of said physical block; an empty unit information manager for retaining a bit map table representing an arrangement of valid data in a management unit together with data to be written in writing data and a logical address; and a controller for selecting an empty physical block based on said empty block management table in writing data into the logical block including the valid data, writing new data into the selected empty physical block, and copying only valid data in the logical block based on said bit map table representing the valid data in the management unit given together with a writing instruction, and in instructing writing of data to said memory controller, said file system notifies said memory controller of area information in said management unit having no valid file data in the logical block of said memory controller.

In the nonvolatile memory system, said address conversion manager may include a next writing pointer representing a next writing position in said logical block.

In the nonvolatile memory system, said controller may notify said file system of a unit of said logical block and receive a data management unit from said file system.

In the nonvolatile memory system, the data management unit received from said file system may be a capacity of a cluster.

In the nonvolatile memory system, said nonvolatile memory may be a flash memory.

To solve the problem, a data writing method of a nonvolatile memory of the present invention for writing data to the nonvolatile memory composed of a plurality of physical blocks based on an instruction from a file system comprises: retaining a bit map table representing an arrangement of valid data in a management unit together with data to be written in writing data and a logical address; selecting an empty physical block in writing data into the logical block including the valid data; writing new data into the selected empty physical block; and copying only valid data in the logical block based on said bit map table representing the valid data in the management unit given together with a writing instruction.

To solve the problem, a computer-readable data writing program of the present invention for writing data into a nonvolatile memory composed of a plurality of physical blocks based on a command from a file system comprises: retaining a bit map table representing an arrangement of valid data in a management unit together with data to be written in writing data and a logical address; selecting an empty physical block in writing data into the logical block including the valid data; writing new data into the selected empty physical block; and copying only valid data in the logical block based on said bit map table representing the valid data in the management unit given together with a writing instruction.

### ADVANTAGES OF THE INVENTION

According to the present invention as described above, in writing, a file system notifies a memory controller of a cluster having no valid file data in a logical block to which written data belongs. The memory controller recognizes unnecessary data based on the information and determines that the data may be abandoned. As a result, it is possible to prevent unnecessary data from being continuously retained. Thus, the writing speed of the nonvolatile memory device can be increased and reliability of the nonvolatile memory device can be improved by reducing the number of times of rewriting of the nonvolatile memory.

### BRIEF DESCRIPTION OF DRAWINGS

FIG. 1 is a configuration diagram showing a nonvolatile memory system in accordance with Embodiment 1 of the present invention.

FIG. 2 is a block diagram showing a configuration of the nonvolatile memory device in accordance with Embodiment 1 of the present invention.

FIG. 3 is a configuration diagram showing the nonvolatile memory in accordance with Embodiment 1 of the present invention.

FIG. 4 is a configuration diagram showing a logical block in accordance with Embodiment 1 of the present invention.

FIG. 5 is a diagram showing an example of an address conversion table.

FIG. 6 is a configuration diagram showing a file management table in accordance with Embodiment 1 of the present invention.

FIG. 7 is a sequence diagram showing exchange of data between a memory access device and a nonvolatile memory device in accordance with Embodiment 1 of the present invention.

FIG. 8 is a diagram showing a state before and after file deletion in accordance with Embodiment 1 of the present invention.

FIG. 9 is a diagram showing a state before and after writing of a new file according to a conventional method after file deletion.

FIG. 10 is a diagram showing a state before and after writing of a new file according to a method in accordance with Embodiment 1 of the present invention after file deletion.

FIG. 11 is a diagram showing an example of bit map data supplied from the memory access device.

FIG. 12 is a configuration diagram showing a nonvolatile memory system in accordance with Embodiment 2 of the present invention.

### EXPLANATION FOR REFERENCE NUMERALS

100, 130 Nonvolatile memory system
101, 131 Nonvolatile memory device
102 Memory access device
103, 133 Nonvolatile memory (Flash memory)
104, 134 Memory controller
105, 135 File system
106 Application
111 Host interface
112 CPU
113 RAM
114 ROM
117 Memory interface
118 Address conversion manager
119 Empty block manager
120 Empty cluster information manager
132 File access device

### BEST MODE FOR CARRYING OUT THE INVENTION

### Embodiment 1

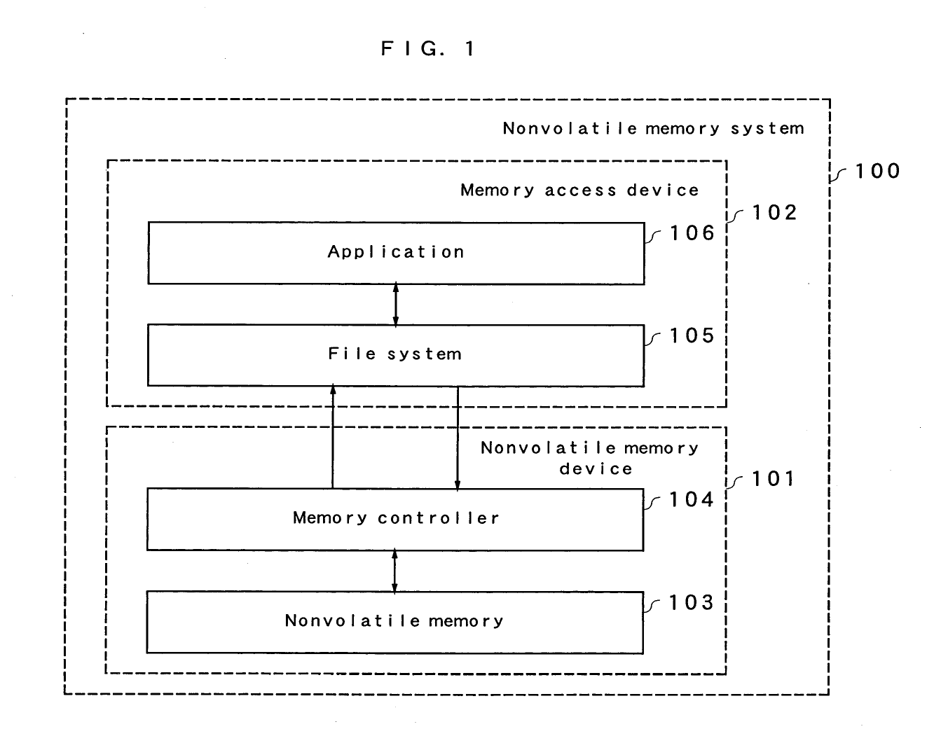

FIG. 1 is a configuration diagram showing a nonvolatile memory system in accordance with Embodiment 1 of the present invention. A nonvolatile memory system 100 includes a nonvolatile memory device 101 for storing data therein and a memory access device 102 for instructing writing and reading of data to the nonvolatile memory device 101. The nonvolatile memory device 101 includes a nonvolatile memory 103 constituted of a flash memory, and a memory controller 104 for controlling writing and reading of user data and memory management information with respect to the nonvolatile memory 103. The memory access device 102 includes a file system 105 for managing a file, and an application 106 for instructing writing and reading of file data and file deletion to the file system 105. The memory access device 102 instructs writing and reading of user data including file data and file management information to the memory controller 104 of the nonvolatile memory device 101 via the file system 105.

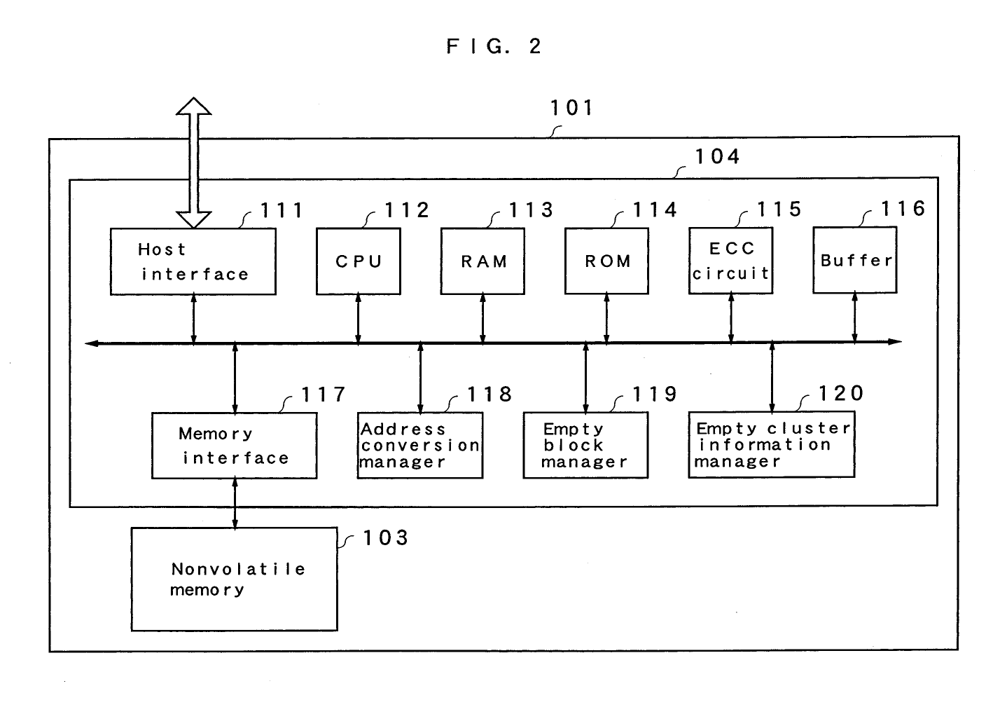

Next, details of the nonvolatile memory device 101 and memory controller 104 will be described referring to FIG. 2. The memory controller 104 provided in the nonvolatile memory device 101 has a host interface 111 and a CPU 112 for controlling the whole of the memory controller. The memory controller 104 includes a RAM 113 as a work area of the CPU 112, a ROM 114 which stores a program executed by the CPU 112 therein, an ECC circuit 115 which performs data error detection and correction, and a buffer 116. The buffer 116 includes a volatile memory having a capacity of 1 page. In addition, a memory interface 117 as an interface with the nonvolatile memory 103, an address conversion manager 118, an empty block manager 119, and an empty cluster information manager 120.

The empty block manager 119 includes an empty block management table indicating whether each physical block is an empty physical block or an occupied physical block, and manages an active physical block according to the table.

The empty cluster information manager 120 is an empty unit information manager for securing an area in which bit map data corresponding to the number of clusters contained in one logical block can be retained based on a cluster size and a logical block size, and managing the bit map data. The cluster size is decided at the memory access device 102, and the logical block represents a unit of data managed by the memory controller.

Here, the CPU 112 has a function of a controller for notifying the memory access device 102 of the logical block size, receiving the cluster unit of data management from the memory access device, and in writing data, copying only valid data based on a bit map table retained in the empty cluster information manager 120.

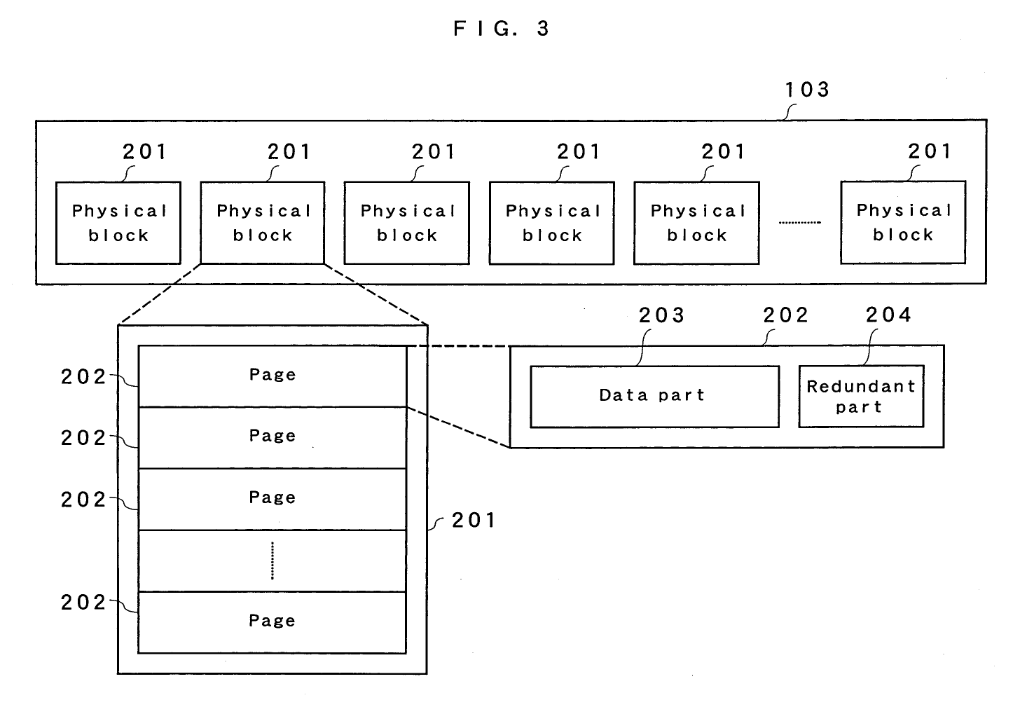

FIG. 3 is a configuration diagram showing the nonvolatile memory 103 in accordance with Embodiment 1 of the present invention. The nonvolatile memory 103 is composed of, for example, a flash memory. The nonvolatile memory 103 is composed of 2048 physical blocks 201. Each physical block is a data erasure unit and has 512 k bytes, for example. Each physical block is composed of a plurality of, for example 128, pages 202. Each page is a data writing/reading unit and a user data area has 4 k bytes, for example. The overall nonvolatile memory 103 has a capacity of 1 G bytes in this example.

Each page is configured a data part 203 for storing user data sent from the file system 105 therein and a redundant part 204 for storing memory management information and ECC code therein. In using each page, the memory controller 104 divides one page into the data part 203 and redundant part 204.

Although data can be written into each page once or a plurality of times, only data in one page cannot be erased. In other words, to erase data, all data in the physical block as the erasure unit must be erased at one time. However, once erased, data can be rewritten in a page unit once or a plurality of times.

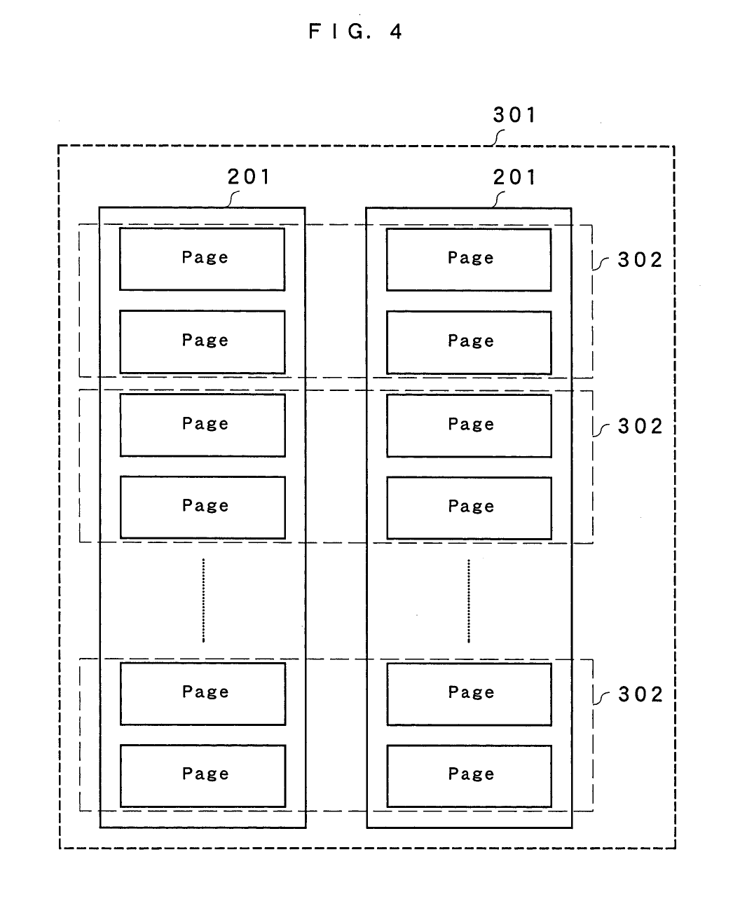

FIG. 4 is a configuration diagram showing a logical block in accordance with Embodiment 1 of the present invention. The memory controller 104 performs a control using the logical block 301 as a memory management unit. The logical block 301 is a virtual memory space associated with a physical block group composed of one or a plurality of physical blocks 201, that is, two physical blocks in the present embodiment. Here, it is assumed that one logical block has 1 M bytes. The logical block and physical block group are not fixedly associated with each other, and in rewriting data, data in the logical block may be transferred to another physical block group.

In the example shown in FIG. 4, two physical blocks are assigned to one logical block. In a case where a plurality of physical blocks constitute the logical block, parallel writing can be performed, thereby advantageously increasing the writing speed. Since data can be written into two pages in parallel at the same time in this case, as compared to a case where one physical block constitutes one logical block, the writing speed increases twice.

Meanwhile, the file management unit of the file system 105 is a cluster 302 and the cluster size is generally smaller than the logical block size. Here, given that one cluster is 16 k bytes, one logical block corresponds to 64 clusters.

FIG. 5 is a diagram showing a configuration of the address conversion manager 118 in accordance with Embodiment 1 of the present invention. The address conversion manager 118 manages a table indicating correspondence between an address of each logical block LB and an address of a physical block PB which records data in the logical block, and assigns the physical block to the logical block at recording of data. Since two physical blocks are assigned to one logical block in this case, addresses of the two physical blocks are recorded. Furthermore, in the present embodiment, a next writing pointer indicating a page in the physical block into which data is successively written is recorded at the same time.

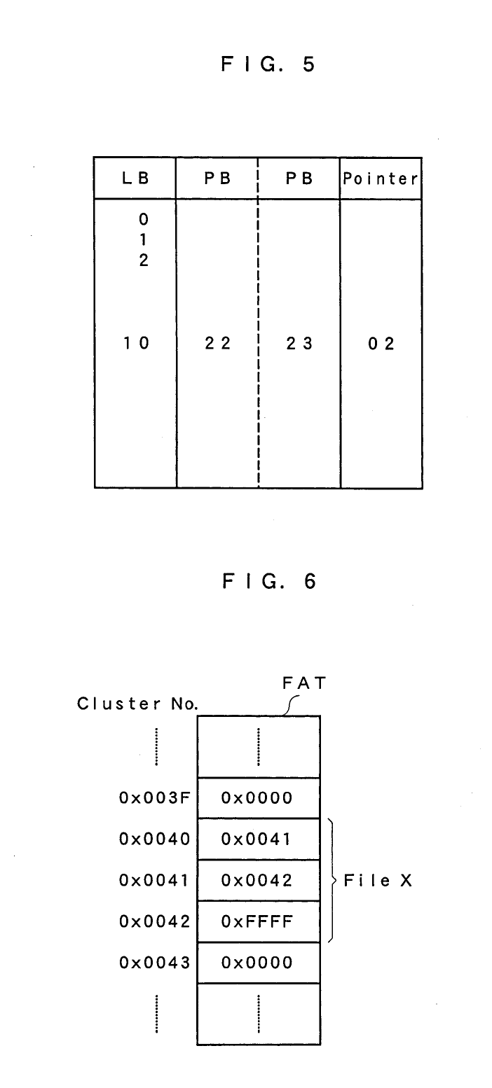

FIG. 6 is a configuration diagram showing a file management table in accordance with Embodiment 1 of the present invention. The file system 105 manages a file including one or a plurality of clusters. Generally, FAT (File Allocation Table) is widely used, for example, as the file management table. In FIG. 6, the order of elements in the file management table corresponds to their cluster numbers and each of the elements represents a next cluster number. However, a value representing an empty cluster (0x0000) and a value representing file termination (0xFFFF) are defined and these values are not treated as the next cluster numbers. FIG. 6 shows an example in which three clusters having the cluster numbers 0x0040, 0x0041 and 0x0042 constitute one file X. The FAT as file management information is stored in an area having a logical address in the vicinity of a lead of the flash memory.

There are various file management methods, and the method is not limited to the file management table described herein, as long as it can manage connection of the clusters can be adopted. Furthermore, a management unit other than the cluster may be used.

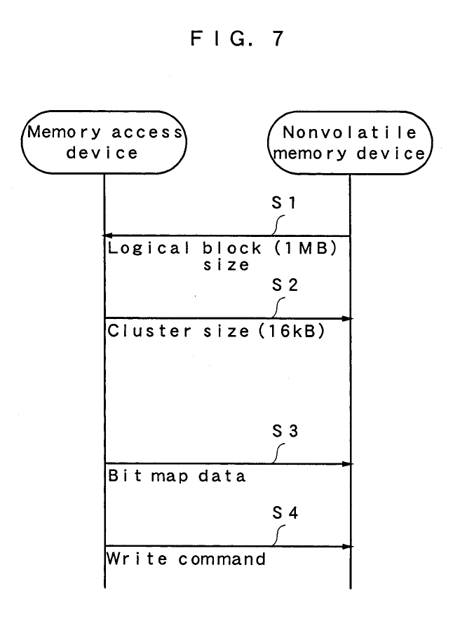

Next, operation in the present embodiment will be described. FIG. 7 is a sequence diagram showing exchange of data between the memory access device and the nonvolatile memory device in the present embodiment. The CPU 112 in the nonvolatile memory device 101 notifies the file system 105 of the logical block size as a unit in which the memory controller 104 manages the nonvolatile memory 103 at initialization (S1). Next, the file system 105 notifies the memory controller 104 of a cluster size as a unit in which the file system 105 manages the file (S2). This step may be performed only once at initialization. In the case where the nonvolatile memory device 101 and memory access device 102 are used as a set at all times, the cluster size may be previously stored in the ROM in the nonvolatile memory device 101 and a logical block size on a memory controller side may be previously stored in the nonvolatile memory area in the memory access device 102.

Information notified between the memory controller 104 and the file system 105 is not necessary the logical block size and cluster size and may be information equivalent to them. For example, the file system 105 may notify the memory controller 104 of the number of clusters per logical block in place of the cluster size.

The order of notification may be reversed. For example, in the case where the logical block size is changed depending on the cluster size of the file system 105, the memory controller 104 may first be notified the cluster size from the file system.

The empty cluster information manager 120 prepares a buffer for bit map data based on the notified cluster size and logical block size. For example, since the logical block is 1 MB and the cluster size is 16 k bytes in the present embodiment, one logical block corresponds to 64 clusters. Accordingly, a buffer which can retain 64 bits of bit map data indicating whether each cluster is valid or empty cluster is prepared.

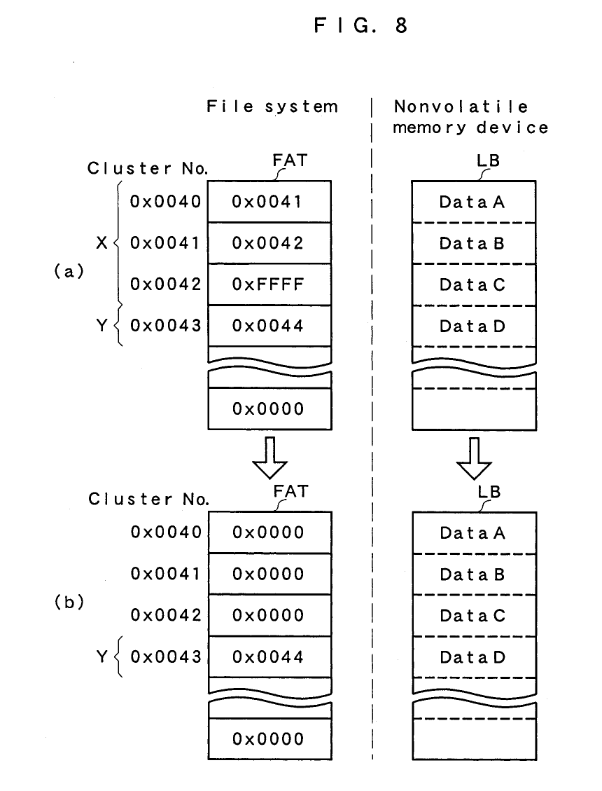

FIG. 8 is a diagram showing a state of the file management table (FAT) in the file system and the logical block of the nonvolatile memory device before and after file deletion in accordance with embodiment 1. In FIG. 8, 64 clusters correspond to a size of one logical block and the clusters 0x0040 to 0x007F corresponds to one logical block LB. In addition, FIG. 8(a) shows a case where a file X composed of cluster numbers 0x0040 to 0x0042 and another file Y beginning from 0x0043 exist in the file management table in the file system. When deleting the file X in this state, as shown in FIG. 8(b), an area in which the file X exists in the file management table in the file system is put into an empty state. In other words, all of the clusters 0x0040 to 0x0042 become 0x0000 and are put into the empty state. On the contrary, a state of the logical block in the nonvolatile memory device which corresponds to the clusters does not change before and after deletion of the file X.

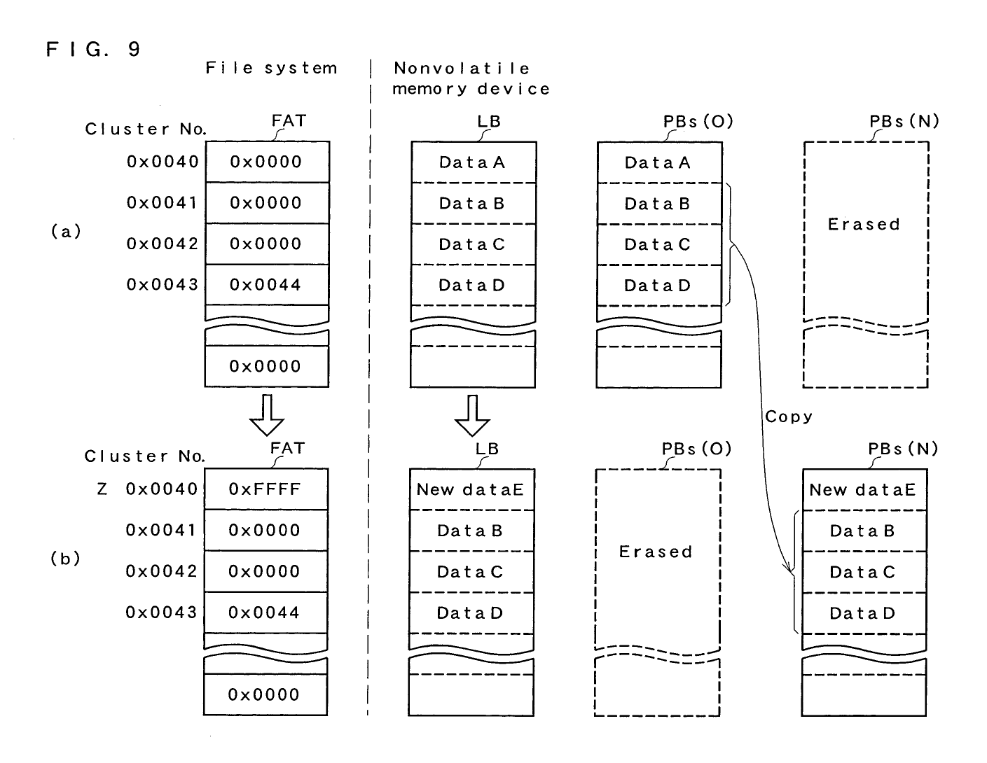

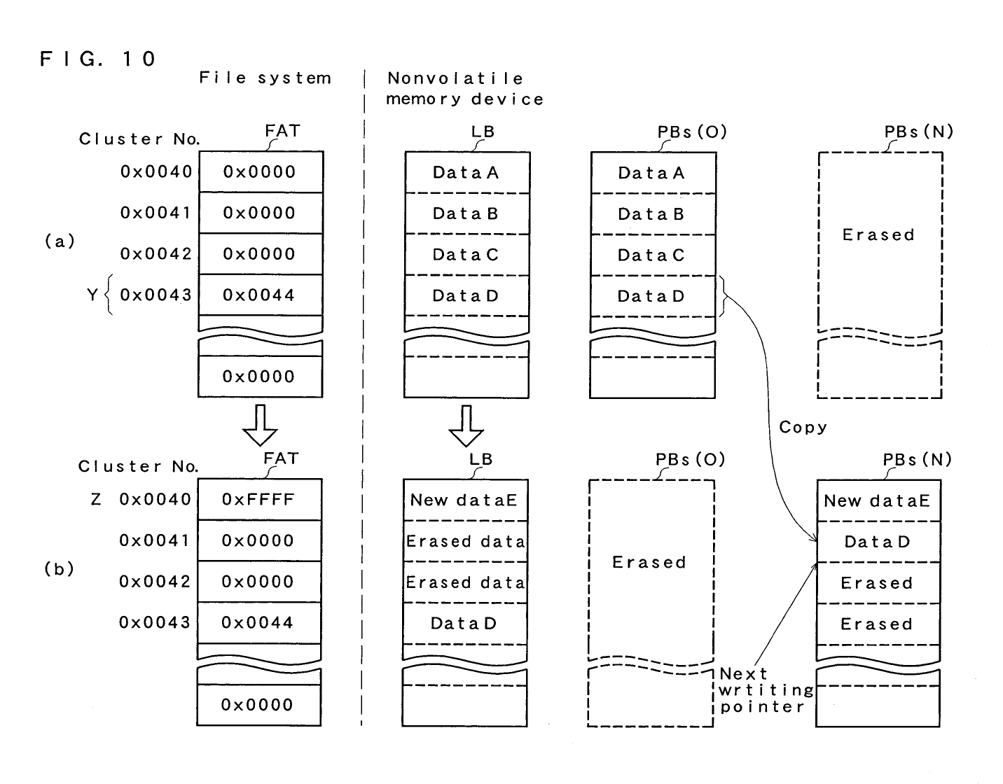

FIG. 9 shows a state before and after writing of a new file Z according to a conventional method after deletion of the file X as shown in FIG. 8. First, as shown in FIG. 9(a), in the nonvolatile memory device, a physical block group PBs (O) is assigned to the logical block LB and data A to D are stored. When a new file is written in this state, as shown in FIG. 9(b), the file system assigns a cluster of the new file to the empty area of the file management table. In this example, the new file Z of one cluster size is assigned to the cluster number 0x0040. At this time, in the logical block LB of the nonvolatile memory device 101 which corresponds to the clusters 0x0040 to 0x007F, the written area is replaced with new data E and data before writing (data B, C and D in this example) is kept in the other areas as it is.

In this writing, as shown in FIG. 9(b), the empty block management table in the empty block manager 119 is searched, a new erased physical block group PBs (N) is secured, and the new data E is written thereinto. The original data B, C and D are copied from the old physical block group PBs (O) to the new physical block group PBs (N).

The old physical block group is transferred to another physical block group as described above in order to perform defect management and wear leveling (leveling of the number of rewriting) of the flash memory and to reduce the buffer size. Since data can be written into the flash memory only after erasure, when an attempt to rewrite a small amount of data in a same physical block group is made, a large buffer corresponding to the block size is required for copying to save most no-rewritten data. However, when the old physical block group is transferred to another physical block group, the data can be rewritten by repeated copying in a small buffer corresponding to a page size, thereby reducing the buffer size.

When all necessary data in the old physical block group are copied and the data in the old physical block group becomes unnecessary, the old physical block group is released, erased, and reused.

Copying of the data B to D need not be performed immediately after writing of new data and can be suspended. In the case of suspension, data in one logical block are divided and stored in two physical block groups, and when the logical block in this state is produced without limit, the capacity is reduced by half. For this reason, the suspended state needs to be resolved at certain timing.

The data D to be copied is valid file data in an occupied cluster, while the data B and C are unnecessary data in an empty state in the file management table. Thus, copying of the data B and C is unnecessary and such coping takes time and results in deterioration of the flash memory.

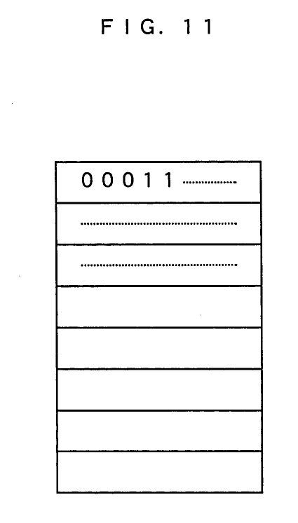

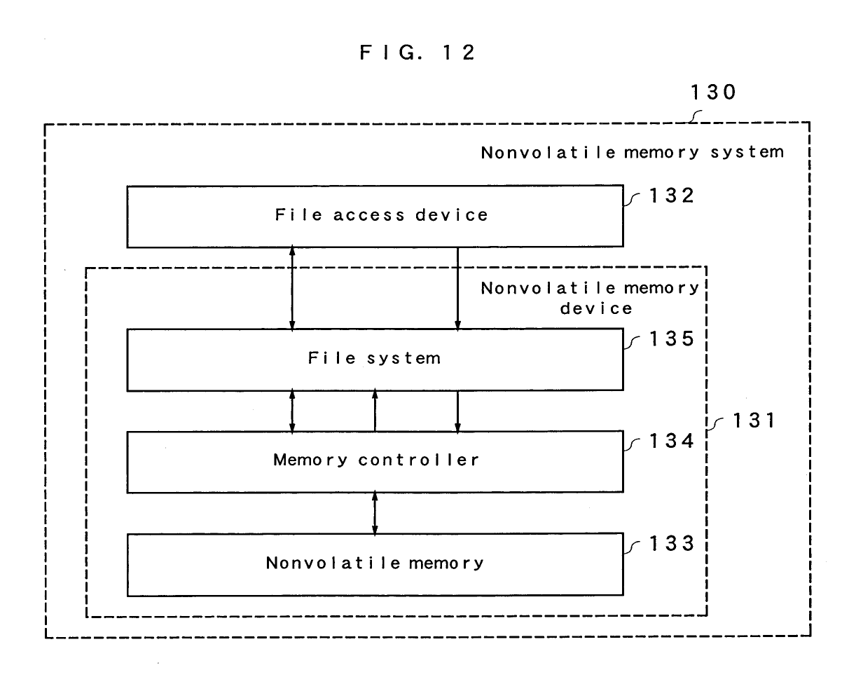

Next, operation for solving the deficiency in the present embodiment will be described. FIG. 10 is a diagram showing the state before and after a new file Z is written according to the method in accordance with Embodiment 1 of the present invention after the file X is deleted in FIG. 8. When instructing writing to the memory controller 104, the file system 105 notifies the memory controller 104 of the nonvolatile memory device of information on an empty cluster having no valid file data in the logical block including a written area (S3). For example, when the file system 105 notifies the information in the bit map given that 0 represents the empty cluster and 1 represents the occupied cluster, 64 bits of bit map data of 0, 0, 0, 1 . . . as shown in FIG. 11, that correspond to the clusters 0x0040, 0x0041, 0x0042, 0x0043 . . . , may be notified.

The nonvolatile memory device retains the bit map data in the empty cluster information manager 120 shown in FIG. 2. Accordingly, the nonvolatile memory device recognizes that data in the logical block corresponding to the empty cluster is unnecessary data and may be abandoned. For example, in this case, the data A to C in FIG. 10 are unnecessary data and may be abandoned.

Then, the file system issues a writing command to write new data E (S4). After writing, the new data E is written into the logical block of the nonvolatile memory device, areas (B, C) as empty clusters become erased data by abandoning data and an area (D) as the occupied cluster is still the original data.

For movement of data in the physical block group, the new erased physical block group PBs (N) is secured and the new data E is written thereinto. Then, the data B and C are not copied and only the data D is copied from the old physical block group to the new physical block group. Since the data B and C are not copied and only necessary data is copied to the new physical block group, after writing, the number of erased areas is increased to use the areas for subsequent writing.

A point from which physical block group has been erased is stored as a next writing pointer in a pointer area of the conversion table in the address conversion manager 118 shown in FIG. 5, and when written into the same logical block, data is written from the point. The next writing pointer may be retained in the address conversion manager 118, stored in the RAM, written into the flash memory, or searched the boundary between the unerased area and the erased area so as to be acquired later.

Although the order of data in the logical block is different from the order of data in the physical block group in FIG. 10(b) showing the state after writing, this can be addressed by writing correspondence therebetween in the redundant part 204 and referring to the correspondence.

As described above, in the present embodiment, the memory controller 104 notifies the file system 105 of the logical block size in advance, on the contrary, the file system 105 notifies the memory controller 104 of the cluster size. In writing, the file system 105 notifies the memory controller 104 of empty cluster information in the cluster unit in the logical block including the written area. Thus, since the memory controller 104 does not uselessly copy unnecessary data based on the empty cluster information, it is possible to provide the memory controller, nonvolatile memory device, file system and nonvolatile memory system which can increase the writing speed and improve reliability by reducing the number of rewriting of the nonvolatile memory.

### Embodiment 2

FIG. 12 is a configuration diagram showing a nonvolatile memory system in accordance with Embodiment 2 of the present invention. A nonvolatile memory system 130 includes a nonvolatile memory device 131 for storing a file therein, and a file access device 132 for instructing writing and reading of file data and file deletion to the nonvolatile memory device 131. The nonvolatile memory device 131 includes a nonvolatile memory 133 composed of a flash memory, and a memory controller 134 for controlling the nonvolatile memory 133 to write and read user data and memory management information, and further includes a file system 135 for instructing writing and reading of user data including file data and file management information to the memory controller 134.

The memory controller 134 and file system 135 in accordance with Embodiment 2 of the present invention perform a similar control to the control by the memory controller 104 and file system 105, respectively, in Embodiment 1 of the present invention. That is, before the file system 135 instructs writing to the memory controller 134, the memory controller 134 notifies the file system 135 of the logical block size as a unit in which the memory controller 134 manages the nonvolatile memory 133. Conversely, the file system 135 notifies the memory controller 134 of a cluster size as a unit in which the file system 135 manages the file. Furthermore, when instructing writing to the memory controller 134, the file system 135 notifies the memory controller 134 of information on an empty cluster having no valid file data in a logical block including a written area. The memory controller 134 determines that data existing in the area may be abandoned based on the received empty cluster information.

Information notified between the memory controller 134 and file system 135 is not necessarily the logical block size and cluster size and only needs to be information equivalent to them. For example, the file system 135 may notify the memory controller 134 of the number of clusters per logical block in place of notifying the cluster size.

In Embodiment 1, for example, in a case where the nonvolatile memory device 101 is a memory card and is accommodated in a housing separately from the memory access device 102, an interface therebetween cannot be easily changed and overhead for notification of information can be incurred. However, in Embodiment 2, the nonvolatile memory 133, memory controller 134, and file system 135 are accommodated in one housing, and a part of the file system 135 and memory controller 134 is composed of software, which is advantageous to application of the present invention due to easy notification of information.

As described above, in the present embodiment, the memory controller 134 notifies the file system 135 of the logical block size, on the contrary, the file system 135 notifies the memory controller 134 of the cluster size. In writing, the file system 135 notifies the memory controller 134 of information on the empty cluster in the logical block including the written area, and the memory controller 134 determined that unnecessary data may be abandoned based on the empty cluster information. Accordingly, since unnecessary copying is not performed, it is possible to constitute a memory controller, nonvolatile memory device, file system, and nonvolatile memory system which can increase writing speed and improve reliability by reducing the number of times of rewriting of a nonvolatile memory.

### INDUSTRIAL APPLICABILITY

In the memory controller, nonvolatile memory device, file system, and nonvolatile memory system according to the present invention, the writing speed is hardly decreased even after file writing and file deletion are repeated and the number of rewriting of the nonvolatile memory is small, so that high reliability can be achieved. The present invention is effective to record data for portable AV equipment such as a still image recording device and moving image recording device, or a portable communication device such as a mobile phone.

1. A memory controller for writing data into a nonvolatile memory composed of a plurality of physical blocks based on a command from a memory access device and reading data from said nonvolatile memory comprising:
an address conversion manager for associating an address of a logical block managing said nonvolatile memory with an address of a physical block retaining data in the logical block;
an empty block manager including an empty block management table representing a usage state of said physical block;
an empty unit information manager for retaining a bit map table representing an arrangement of valid data in a management unit together with data to be written in writing data and a logical address; and
a controller for selecting an empty physical block based on said empty block management table in writing data into the logical block including the valid data, writing new data into the selected empty physical block, and copying only valid data in the logical block based on said bit map table representing the valid data in the management unit given together with a writing command.

2. The memory controller according to claim 1, wherein said address conversion manager includes a next writing pointer representing a next writing position in said logical block.

3. The memory controller according to claim 1, wherein said controller notifies an external memory access device of a unit of said logical block and receives a data management unit from said memory access device.

4. The memory controller according to claim 3, wherein the data management unit received from said memory access device is a capacity of a cluster.

5. A nonvolatile memory device, comprising:
a nonvolatile memory composed of a plurality of physical blocks; and
a memory controller for writing data into said nonvolatile memory based on a command from a memory access device and reading data from said nonvolatile memory, wherein
said memory controller includes:
an address conversion manager for associating an address of a logical block managing said nonvolatile memory with an address of a physical block retaining data in the logical block;
an empty block manager including an empty block management table representing a usage state of said physical block;
an empty unit information manager for retaining a bit map table representing an arrangement of valid data in a management unit together with data to be written in writing data and a logical address; and
a controller for selecting an empty physical block based on said empty block management table in writing data into the logical block including the valid data, writing new data into the selected empty physical block, and copying only valid data in the logical block based on said bit map table representing the valid data in the management unit given together with a writing command.

6. The nonvolatile memory device according to claim 5, wherein said address conversion manager includes a next writing pointer representing a next writing position in said logical block.

7. The nonvolatile memory device according to claim 5, wherein said controller notifies an external memory access device of a unit of said logical block and receives a data management unit from said memory access device.

8. The nonvolatile memory device according to claim 7, wherein the data management unit received from said memory access device is a capacity of a cluster.

9. The nonvolatile memory device according to claim 5, wherein said nonvolatile memory is a flash memory.

10. A file system for writing and reading data with respect to a nonvolatile memory device, wherein
in writing data into said nonvolatile memory device, area information in a management unit having no valid file data in the logical block of said nonvolatile memory device is notified to said nonvolatile memory device.

11. A nonvolatile memory device, comprising:
a nonvolatile memory composed of a plurality of physical blocks;
a memory controller for writing data to said nonvolatile memory and reading data from said nonvolatile memory; and
a file system for instructing writing and reading of data with respect to said memory controller, wherein
said memory controller includes:
an address conversion manager for associating an address of a logical block managing said nonvolatile memory with an address of a physical block retaining data in the logical block;
an empty block manager including an empty block management table representing a usage state of said physical block;
an empty unit information manager for retaining a bit map table representing an arrangement of valid data in a management unit together with data to be written in writing data and a logical address; and
a controller for selecting an empty physical block based on said empty block management table in writing data into the logical block including the valid data, writing new data into the selected empty physical block, and copying only valid data in the logical block based on said bit map table representing the valid data in the management unit given together with a writing instruction, and
in instructing writing of data to said memory controller, said file system notifies said memory controller of area information in said management unit having no valid file data in the logical block of said memory controller.

12. The nonvolatile memory device according to claim 11, wherein said address conversion manager includes a next writing pointer representing a next writing position in said logical block.

13. The nonvolatile memory device according to claim 11, wherein said controller notifies said file system of a unit of said logical block and receives a data management unit from said file system.

14. The nonvolatile memory device according to claim 13, wherein the data management unit received from said file system is a capacity of a cluster.

15. The nonvolatile memory device according to claim 11, wherein said nonvolatile memory is a flash memory.

16. A nonvolatile memory system, comprising:
a nonvolatile memory composed of a plurality of physical blocks;
a memory controller for writing data to said nonvolatile memory and reading data from said nonvolatile memory;
a file system for instructing writing and reading of data with respect to said memory controller; and
a file access device for writing, reading, and deletion of a file, wherein
said memory controller includes:
an address conversion manager for associating an address of a logical block managing said nonvolatile memory with an address of a physical block retaining data in the logical block;
an empty block manager including an empty block management table representing a usage state of said physical block;
an empty unit information manager for retaining a bit map table representing an arrangement of valid data in a management unit together with data to be written in writing data and a logical address; and
a controller for selecting an empty physical block based on said empty block management table in writing data into the logical block including the valid data, writing new data into the selected empty physical block, and copying only valid data in the logical block based on said bit map table representing the valid data in the management unit given together with a writing instruction, and
in instructing writing of data to said memory controller, said file system notifies said memory controller of area information in said management unit having no valid file data in the logical block of said memory controller.

17. The nonvolatile memory system according to claim 16, wherein said address conversion manager includes a next writing pointer representing a next writing position in said logical block.

18. The nonvolatile memory system according to claim 16, wherein said controller notifies said file system of a unit of said logical block and receives a data management unit from said file system.

19. The nonvolatile memory system according to claim 18, wherein the data management unit received from said file system is a capacity of a cluster.

20. The nonvolatile memory system according to claim 16, wherein said nonvolatile memory is a flash memory.

21. A data writing method of a nonvolatile memory for writing data to the nonvolatile memory composed of a plurality of physical blocks based on an instruction from a file system, comprising:
retaining a bit map table representing an arrangement of valid data in a management unit together with data to be written in writing data and a logical address;
selecting an empty physical block in writing data into the logical block including the valid data;
writing new data into the selected empty physical block; and
copying only valid data in the logical block based on said bit map table representing the valid data in the management unit given together with a writing instruction.

22. A computer-readable data writing program for writing data into a nonvolatile memory composed of a plurality of physical blocks based on a command from a file system, comprising:
retaining a bit map table representing an arrangement of valid data in a management unit together with data to be written in writing data and a logical address;
selecting an empty physical block in writing data into the logical block including the valid data;
writing new data into the selected empty physical block; and
copying only valid data in the logical block based on said bit map table representing the valid data in the management unit given together with a writing instruction.
